(19) United States
(12) Patent Application Publication
(10) Pub. No.: US 2002/0089773 A1
(43) Pub. Date: Jul. 11, 2002

(54) Disk drive including preamplifier for perpendicular magnetic recording system

(76) Inventors: Kazuhito Shimomura, Akishima-shi (JP); Koji Osafune, Ome-shi (JP); Yuji Sakai, Yokohama-shi (JP)

Correspondence Address: PILLSBURY WINTHROP, LLP, P.O. BOX 10500, MCLEAN, VA, 22102, US

(21) Appl. No.: 10/025,979

(22) Filed: Dec. 26, 2001

(30) Foreign Application Priority Data
Dec. 27, 2000 (JP) 2000-397291
Feb. 26, 2001 (JP) 2001-050454

(51) Int. Cl. G11B 5/02

(52) U.S. Cl. 360/67

(57) ABSTRACT

There is disclosed a disk drives of the perpendicular magnetic recording system capable of using a data channel of the longitudinal magnetic recording system. The drive has a preamplifier including a differentiation circuit which differentiates a read signal output from a read head. The preamplifier includes an adjusting circuit which adjusts low cut-off frequency for restricting waveform deformation of a read signal of rectangular waveform, as a front stage of the differentiation circuit.

### CROSS-REFERENCE TO RELATED APPLICATIONS

This application is based upon and claims the benefit of priority from the prior Japanese Patent Applications No. 2000-397291, filed Dec. 27, 2000; and No. 2001-050454, filed Feb. 26, 2001, the entire contents of both of which are incorporated herein by reference.

### BACKGROUND OF THE INVENTION

1. Field of the Invention

The present invention generally relates to a disk drive employing a perpendicular magnetic recording system, more specifically, the invention relates to a technology of a preamplifier that amplifies read signals reproduced from a disk medium.

2. Description of the Related Art

In recent years, in the field of disk drives represented mainly by hard disk drives, development has been progressed in the perpendicular magnetic recording system that offers high realization of ultra high recording density, as well as the conventional longitudinal magnetic recording system. In the development of products of disk drives employing the perpendicular magnetic recording system, it is preferable by utilize the technology of the longitudinal magnetic recording system, and to minimize change elements in practical applications.

In disk drives of the perpendicular magnetic recording system, one of the technical subjects toward practical applications is signal processing for generating reproduction data from read signals read by a read head from a disk. In the longitudinal magnetic recording system, a read signal waveform read by the read head is of a Lorentz approximate waveform (or single peak waveform). On the other hand, in the perpendicular magnetic recording system, its read signal waveform is of a rectangular waveform including a DC component.

In disk drives of the perpendicular magnetic recording system, it is supposed that a double-layered disk medium is employed as a disk medium as a recording medium. The double-layered disk medium has a structure having a recording magnetic layer showing perpendicular magnetic anisotropy, and a soft magnetic layer between the recording magnetic layer and a substrate. As a magnetic head, a head having a structure wherein a read head and a write head are separately arranged is employed. The read head is structured by a giant magneto resistive element (GMR element). While, the write head is, for example, a single pole type head.

In short, the signal processing method employed in the conventional longitudinal magnetic recording system cannot be applied to the perpendicular magnetic recording system as it is. As methods to solve the technical subject concerning such the signal processing method, the following technical suggestions have been made conventionally.

Namely, as a first prior art, a signal processing LSI wherein (1, 7) RLL encoding method and positive coefficient PRML method are applied as a read/write channel of a disk drive of the perpendicular magnetic recording system is suggested (refer to, for example, Jpn. Pat. Appln. KOKAI Publication No. 11-66755). As a second prior art, a signal processing LSI (read channel) having a differentiation circuit which differentiates a rectangular read signal waveform read from a perpendicular magnet recorded disk one time is suggested (refer to, for example, Jpn. Pat. Appln. KOKAI Publication No. 4-286702). This read channel converts the rectangular read signal waveform into a differentiation waveform by the differentiation circuit, therefore, a signal processing circuit of partial response (PR) class 4 system employed in the conventional longitudinal magnetic recording system may be used as it is.

However, in the first prior art mentioned above, in order to apply it to actual disk drives of the perpendicular magnetic recording system, it is required to develop and improve various technologies including ones in a waveform equalization circuit and the like. As a consequence, it is not available to use the signal processing LSI of the conventional longitudinal magnetic recording system as it is, and it is necessary to design a new signal processing LSI applicable for disk drives of the perpendicular magnetic recording system that can be made into products. Accordingly, in consideration of development costs, development hours and the like, at present, it is not possible to apply the first prior art into practical disk drives of the perpendicular magnetic recording system, which has been a problem with the prior art.

On the other hand, in the second prior art, by use of the differentiation circuit for differentiating a read signal waveform of rectangular waveform, a circuit of PR4 system employed in the longitudinal magnetic recording system may be employed as a signal processing circuit at rear stage. In short, the differentiation circuit has a function to convert a read signal waveform of the perpendicular magnetic recording system mostly into a read signal waveform of the longitudinal magnetic recording system. Accordingly, in viewpoints of development costs, hours and the like, the second prior art may be the technology likely to be at practical level.

However, the concrete constitution for incorporating a differentiation circuit in the signal processing LSI configuring an actual read/write channel is just under development. On the while, in actual disk drives, read signals read by the read head (GMR element) is amplified by a preamplifier (also referred to as a head amplifier) as the front stage of read/write channel. With respect to a rectangular read signal waveform by the perpendicular magnetic recording system, it has been confirmed that when amplified by the conventional preamplifier, the read signal waveform is subject to deformation under influence of low cut-off frequency. For this reason, a differentiation circuit included in a read/write channel differentiates a read signal waveform having deformation. As a consequence, in the read/write channel, data reproduction processing is carried out from a read signal of differentiation waveform with deformation. As a result, this second prior art is not enough for practical application, either, which has been another problem with the prior art.

### BRIEF SUMMARY OF THE INVENTION

The present invention has been made in consideration of the problems with the prior art, accordingly, an object of the present invention is to provide a disk drive of a perpendicular magnetic recording system, that enables to employ a read signal processing circuit of the conventional longitudinal magnetic recording system, and to realize data reproduction performance at practical application level.

In accordance with one aspect of the present invention, there is provided a disk drive including perpendicular magnetic recording system. The disk drive comprises:

a disk medium for perpendicular magnetic recording;

a read head which reads a perpendicular magnetic recorded data signal from the disk medium;

a preamplifier circuit including an amplifier which amplifies a read signal output from the read head, and a differentiation circuit which differentiates a read signal waveform output from the amplifier; and

a data channel which reproduces data from the read signal output from the preamplifier circuit.

### BRIEF DESCRIPTION OF THE SEVERAL VIEWS OF THE DRAWING

FIG. 1 is a block diagram showing major components of a preamplifier included in a disk drive according to a first embodiment of the present invention;

FIG. 2 is a block diagram showing major components of the disk drive according to the embodiment;

FIG. 3 is a block diagram showing major components of a read/write channel according to the embodiment;

FIG. 4 is a block diagram showing major components of a preamplifier according to a modified example of the embodiment;

FIGS. 5A and 5B are diagrams showing read signal waveforms in the preamplifier according to the embodiment;

FIG. 6 is a diagram showing the relations of low cut-off frequency and error rate according to the embodiment;

FIG. 7 is a block diagram showing major components of a disk drive according to a second embodiment of the present invention;

FIGS. 8A to 8E are timing charts for explaining TA detection operation according to the embodiment;

FIGS. 9A and 9B are diagrams showing magnetic recording and read signal waveform in the prior longitudinal magnetic recording system;

FIGS. 10A to 10C are diagrams showing magnetic recording and read signal waveform in the perpendicular magnetic recording system according to the embodiment;

FIGS. 11A and 11B are diagrams for explaining a TA phenomenon according to the embodiment; and

FIGS. 12A and 12B are diagrams for explaining TA detection by the perpendicular magnetic recording system according to the embodiment.

### DETAILED DESCRIPTION OF THE INVENTION

(First Embodiment)

A first embodiment will be explained hereafter in reference with the attached drawings.

(Constitution of Disk Drive)

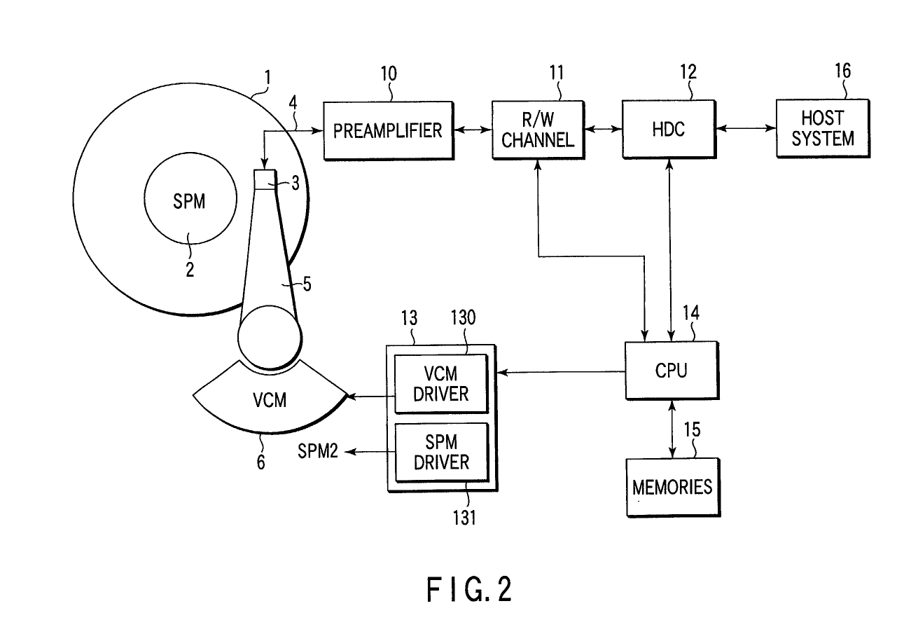

A disk drive according to the embodiment is a drive employing a perpendicular magnetic recording system. As shown in FIG. 2, the disk drive comprises a double-layered disk 1 having its magnetic anisotropy in vertical direction, a spindle motor (SPM) 2 for rotating the disk 1, and an actuator loading a magnetic head 3.

The magnetic head 3 has a structure wherein a read head comprising a GMR element, and a write head comprising an inductive type single pole type head are packaged onto a slider. The actuator comprises an arm (including suspension) 5 holding the magnetic head 3, and a voice coil motor (VCM) 6 for generating driving force. The actuator positions the head 3 on a target position (access objective track) on the disk 1, by servo control of a micro processor (CPU) 14.

Further, the disk drive has a preamplifier 10 to be described later, a read/write (R/W) channel 11, a disk controller (HDC) 12, the CPU 14, memories 15, and a motor driver 13.

The R/W channel 11 is a signal processing circuit (LSI) at the rear stage of the preamplifier 10, and includes read channel and write channel. The read channel executes signal processing of, for example, PR4 system partial response maximum likelihood method (PRML method), and decodes data (including servo data) from read signals. The write channel executes encoding processing (for example, RLL encoding method) of write data transferred from the HDC 12.

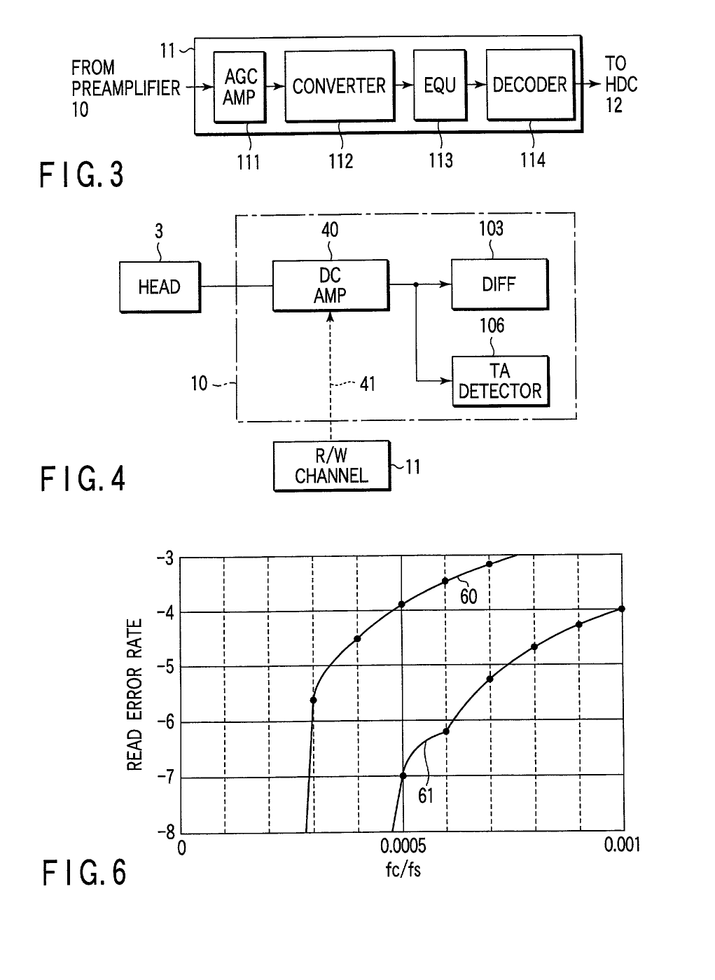

The read channel included in the R/W channel 11, as shown in FIG. 3, comprises an auto gain control (AGC) amplifier 111 for maintaining an amplitude level of read signals at a certain level, a signal conversion circuit 112 including a low-pass filter and an A/D converter, an equalizer (for example, a digital filter) 113 for executing waveform equalization processing, and a decoder (including a Viterbi decoder and an NRZ decoder) 114. The R/W channel 11 sends decoded user data to the HDC 12.

The HDC 12, as shown in FIG. 2, configures an interface between the drive and a host system (a personal computer or a digital device) 16, and executes transfer control of read/write data and the like. The CPU 14 is a main controller of the drive, and executes the servo control of the magnetic head 3, and the read/write control. The CPU 14 controls seek operation and track following operation, in accordance with the servo data reproduced by the R/W channel 11. More concretely, the CPU 14 controls an input value (control voltage value) of a VCM driver 130, thereby drives and controls the VCM 6 of the actuator. The memories 15 include a RAM, a ROM, and a flash EEPROM, and store a control program and various control data of the CPU 14. The motor driver 13 has the VCM driver 130, and a SPM driver 131 for driving the spindle motor (SPM) 3.

(Constitution of Preamplifier)

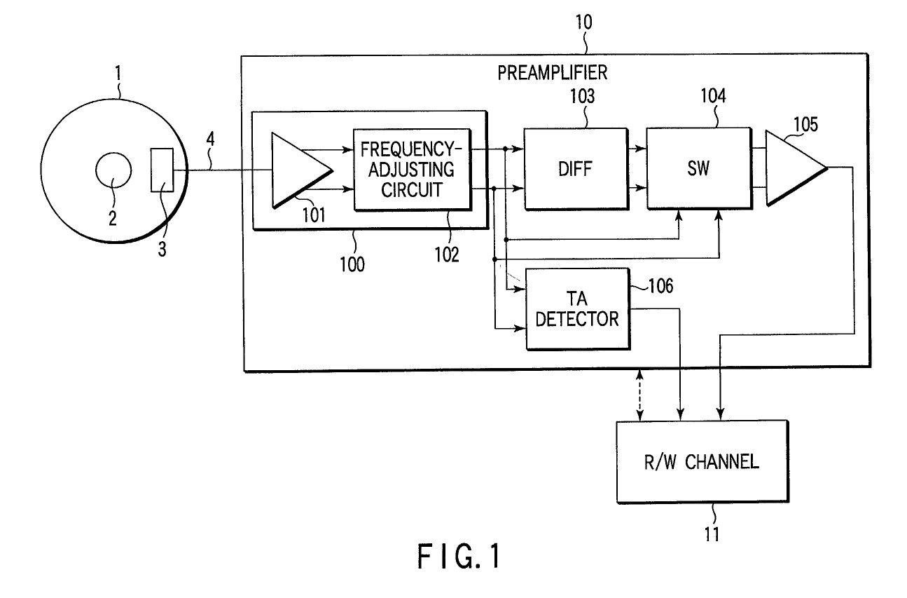

The preamplifier according to the embodiment, as shown in FIG. 1, has a read amplifier circuit 100 for inputting and amplifying the read signals (rectangular waveform in the perpendicular magnetic recording system) 4 output from the read head included in the magnetic head 3. Further, the preamplifier circuit 10 has a differentiation circuit 103, a selection circuit 104, a gain adjusting circuit 105, and a thermal asperity (TA) detection circuit 106.

The read amplifier circuit 100 has a differential amplifier 101, and a frequency adjusting circuit 102 for adjusting low cut-off frequency (fc). The differential amplifier 101 amplifies read signals output from the read head. The frequency adjusting circuit 102 sets the low cut-off frequency (fc) at the differential amplifier 101, preferably at 50 kHz or less or in the range of from 1/2000 or less of the maximum recording frequency of the disk 1 to a DC level, so as to reproduce a read signal waveform of rectangular waveform read by the read head from the perpendicular magnetic recording disk 1. The frequency adjusting circuit 102 comprises, for example, a programmable filer of which parameters may be adjusted by the CPU 14.

The differentiation circuit 103 differentiates the read signal waveform output from the read amplifier circuit 100 and converts it into a differentiation waveform. The differentiation circuit 103 comprises a high-pass filter (HPF) for conversion into read signals of Lorentz approximate waveform applicable to the conventional longitudinal magnetic recording system, and the like. The gain adjusting circuit 105 comprises an amplifier which execute gain adjustment for controlling a saturation phenomenon by the read amplifier circuit 100. The gain adjusting circuit 105 sends read signals after the gain adjustment to the R/W channel 11.

The TA detection circuit 106 is a well known circuit for detecting a thermal asperity phenomenon (TA phenomenon) that occurs by the GMR element used as the read head, and outputs detected signals to the R/W channel 11.

Besides the read amplifier circuit 100, the preamplifier 10 includes a write amplifier circuit for converting write data into write current (refer to FIG. 7).

(Operation of Preamplifier Circuit)

In the read operation of the disk drive, the read signal 4 read by the read head (GMR element) from the perpendicular magnetic recorded double-layered disk 1 is transferred to the preamplifier 10. Herein, in the read amplifier circuit 100, as mentioned above, the low cut-off frequency (fc) is adjusted by the frequency adjusting circuit 102 at 50 kHz or less or in the range of from 1/2000 or less of the maximum recording frequency of the disk 1 to a DC level. By this read amplifier circuit 100, the read signal 4 is amplified and sent to the differentiation circuit 103.

The selection circuit 104 selects the output of the differentiation circuit 103 according to selection instructions of the perpendicular magnetic recording system by the CPU 14, and sends the selected one to the gain adjusting circuit 105. The gain adjusting circuit 105 sends the read signal, which has been converted from the rectangular waveform of the perpendicular magnetic recording system into the Lorentz waveform of the longitudinal magnetic recording system by the differentiation circuit 103, to the R/W channel 11 after predetermined gain adjustment.

On the other hand, when the selection of the conventional longitudinal magnetic recording system is instructed by the CPU 14, of course, the selection circuit 104 selects the read signal waveform output from the read amplifier circuit 100, and sends the selected one to the gain adjusting circuit 105. However, in this case, in the read amplifier circuit 100, according to the instruction from the CPU 14, the low cut-off frequency (fc) applicable for the longitudinal magnetic recording system is adjusted by the adjusting circuit 102 at, for example, 500 kHz (or, for example, 350 kHz or more). In the R/W channel 11, in normal cases, the PRML signal processing method of negative coefficient is supposed.

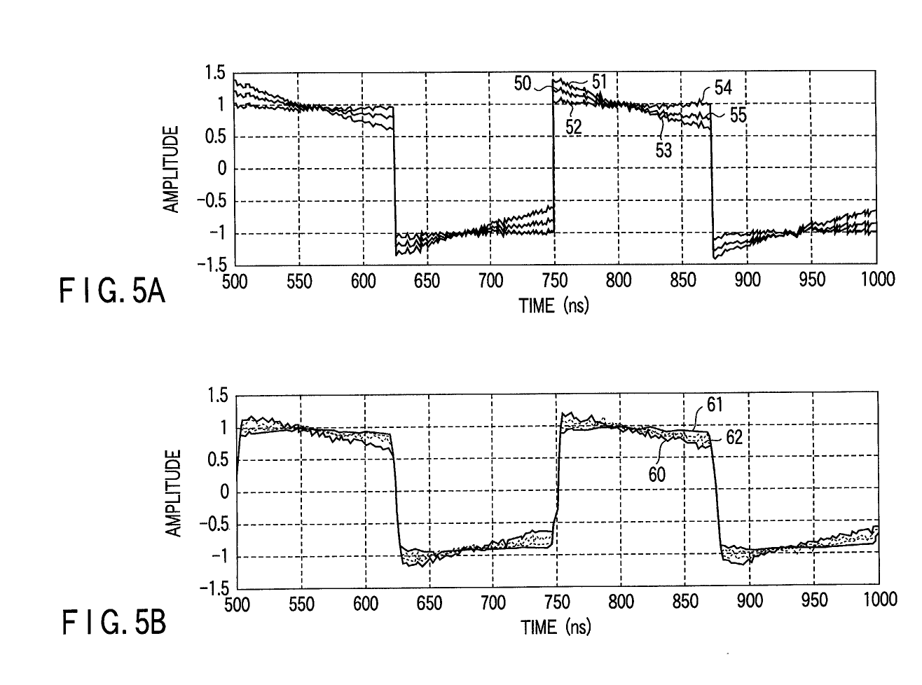

FIG. 5A is a diagram showing results of calculations of the read signal waveform (rectangular waveform in the perpendicular magnetic recording system) corresponding to the low cut-off frequency (fc) in the read amplifier circuit 100 by computer simulation. Specifically, the figure shows a read signal waveform 50 in the case where fc is 1 MHz, a read signal waveform 51 in the case where fs is 500 kHz, a read signal waveform 52 in the case where fc is 100 kHz, and a read signal waveform 53 in the case where fs is 50 kHz, respectively.

Herein, in the disk drive of the conventional longitudinal magnetic recording system, the low cutoff frequency (fc) of the read amplifier circuit 100 is set to about 500 kHz. This is because, in a general disk drive, transfer rate shifts to the high range along with high recording density, and along with this, fc also shifts to the high frequency side. Accordingly, along with the high transfer rate of a disk drive, there is a tendency that fc is further increasing. In a disk drive for high transfer rate, the low cut-off frequency (fc) of the read amplifier circuit 100 is set, for example, at the range of 1 to 3 MHz.

However, as mentioned above, in order to precisely reproduce the read signal waveform of rectangular waveform by the perpendicular magnetic recording system, it is preferable to set the low cutoff frequency to at least ⅕ or less of the conventional one, i.e., 100 kHz or less, and ideally 1/10 or less, i.e., 50 kHz or less. In the low cutoff frequency (fc) at high range, there is a high possibility that waveform deformation exceeding an allowable range is occurred in the read signal amplified by the read amplifier circuit 100.

FIG. 5B shows results of actual measurement of a read signal waveform 60 in the case where fc is set to, for example, 1 MHz or more and a read signal waveform 62 in the case where fc is set at 350 kHz range. As is clearly seen from the results of this actual measurement, especially when fc is set to 1 MHz or more, it is confirmed that waveform deformation in the read signal waveform 60 becomes large. If such a read signal waveform with waveform deformation is sent to the R/W channel 11 at the rear stage, there is a high possibility that erroneous reproduction data is extracted, leading to deterioration in read error rate.

Therefore, as the preamplifier 10 applicable for the perpendicular magnetic recording system of the embodiment, it is configured so that the read signal 4 of rectangular waveform of the perpendicular magnetic recording system is amplified by the read amplifier circuit 100 of which fc is adjusted to at least ⅕ or less of the conventional one, i.e., 100 kHz or less, and ideally 1/10 or less, i.e., 50 kHz or less. Accordingly, the influence of waveform deformation upon the read signal waveform to be amplified is reduced, and it is possible to increase the reproduction performance of the read signal waveform of rectangular waveform. The differentiation circuit 103 enables, when converting the read signal waveform of rectangular waveform of the perpendicular magnetic recording system into the read signal waveform of Lorentz waveform of the longitudinal magnetic recording system, to convert that into the read signal waveform capable of reproducing data precisely. Thereby, it is possible for the R/W channel 11 to reproduce normal data from a high quality read signal waveform from the preamplifier 10. Accordingly, by applying the preamplifier 10 of the embodiment to the disk drive of the perpendicular magnetic recording system, it is possible to increase read error rate in read operation.

FIG. 6 is a diagram showing relations between especially the recording frequency (fs) on the disk 1 and the read error rate (ER), concerning to the adjustment of low cut-off frequency (fc) of the read amplifier circuit 100. Herein, ER characteristics 60 and 61 are for the case where the R/W channel is of E2PR4 class PRML signal processing method.

The low cut-off frequency (fc) of the preamplifier circuit applicable for the conventional longitudinal magnetic recording system is set to, for example, 350 kHz or more. Herein, when a recording frequency (fs) is 200 MHz, it stands that “fc/fs=1/570”. On the other hand, if the low cut-off frequency (fc) characteristics are made of the first degree, read error rate is deteriorated in the case of “fc/fs=1/2000 or more” (refer to the characteristics 61 in FIG. 6). Further, if the low cut-off frequency (fc) characteristics are made of the second degree, read error rate is deteriorated in the case of “fc/fs=1/3000 or more” (refer to the characteristics 60 in FIG. 6).

Accordingly, in an E2PR4 class R/W channel, it is preferable to adjust the low cut-off frequency (fc) of the read amplifier circuit 100 so as to attain “fc/fs=1/2000 or less” or “fc/fs=1/4000 or less”. In a PR3 class R/W channel, it is preferable to adjust the low cut-off frequency (fc) so as to attain “fc/fs=1/1000 or less”.

Further, as a preferred concrete example, when recording frequency (fs) is 300 MHz, the low cut-off frequency (fc) of the read amplifier circuit 100 is adjusted to 30 kHz so as to attain “fc/fs=1/10000”.

In the preamplifier 10 of the embodiment, the TA detection circuit 106 is, as mentioned above, the circuit for detecting the TA phenomenon. The R/W channel 11 can include predetermined compensation processing against TA phenomenon in reproduction process, according to the detected signal from the TA detection circuit 106.

As mentioned above, the preamplifier circuit 10 of the embodiment has the gain adjusting circuit 105, and thereby adjust the gain of the whole amplifier. In general, the output of the read head of the longitudinal magnetic recording system is on the order of 1 to 2 mvpp. In consideration of the S/N rate of a recording/reproducing system, the input range of the R/W channel at the rear stage is designed on the order of 200 mvpp to 300 mvpp.

However, in the perpendicular magnetic recording system, the output level of the read head can be made significantly large in comparison with the longitudinal magnetic recording system. In concrete, the output of the read head may be made, for example, over 4 mvpp. Therefore, there is a high possibility that the output of the preamplifier circuit 10 with conventional gain is subject to saturation. Accordingly, in the preamplifier circuit 10 of the embodiment, the amplifier gain of about 100 times to 200 times of the conventional one is reduced to around 50 times by the gain adjusting circuit 105, thereby it is possible to control saturation over the whole amplifier. Thereby, in the R/W channel 111 at the rear stage, it is possible to avoid the case where an input dynamic range goes over the range.

In the read amplifier circuit 100 of the embodiment, the differential amplifier 101 is employed. In general, from viewpoint of S/N rate, differential amplification by the differential amplifier 101 is preferable, while even another kind of amplifier may be applied to the read amplifier circuit 100 of the embodiment.

### MODIFIED EXAMPLE

FIG. 4 is a diagram showing a modified example of the embodiment. This modified example relates to a preamplifier 10 where the read amplifier circuit 100 of the embodiment is configured by a DC amplifier 40. Herein a bias adjusting signal line 41 is required for adjusting a bias level of the DC amplifier 40 by the adjusting signal from the R/W channel 11. It is preferable that the R/W channel 11 includes a read channel of a positive coefficient PRML signal processing method applicable for the perpendicular magnetic recording system.

Further as another modified example of the embodiment, when the output of the differentiation circuit 103 is not selected by the selection circuit 104, there is provided a constitution of disk drive wherein a power supply control circuit is arranged for shutting down the power supply of the differentiation circuit 103. By such a constitution, it is possible to prevent wasteful electricity consumption by the differentiation circuit 103, therefore it is possible to realize low electricity effects.

Summing up, as a preamplifier to meet a disk drive of the perpendicular magnetic recording system, a preamplifier having a read amplifier including an adjusting circuit for adjusting low cut-off frequency (fc), and a differentiation circuit for converting a read signal waveform of rectangular waveform into a differentiation waveform. Such a preamplifier can control deformation by low cut-off frequency occurring in read signal waveform of rectangular waveform in the perpendicular magnetic recording system. As a consequence, the differentiation circuit differentiates read signals of rectangular waveform wherein waveform deformation and the like are restricted, and outputs a differentiation waveform signal, as a result, it is possible to generate a high quality read signal waveform applicable for the longitudinal magnetic recording system. Thereby, when a disk drive of the perpendicular magnetic recording system is designed, as a signal processing circuit (signal processing LSI) for reproducing data from a read signal, for example, a PR4 system circuit to meet the longitudinal magnetic recording system may be employed. Accordingly, from viewpoints of development costs and development hours, it is possible to provide a disk drive of the perpendicular magnetic recording system at practical application level.

(Second Embodiment)

FIG. 7 is a block diagram showing major components of a disk drive of the perpendicular magnetic recording system according to a second embodiment of the present invention.

The second embodiment appears as a disk drive having a constitution wherein a TA detection circuit for detecting thermal asperity (TA) occurring by a GMR element used as a read head is arranged at a R/W channel 11.

In the disk drive of the second embodiment, as shown in FIG. 7, a TA detection circuit 111 is included in not a preamplifier circuit 10, but the R/W channel 11. The preamplifier circuit 10, as mentioned above, includes a read amplifier circuit 100 for amplifying read signals read by the read head, a differentiation circuit 103, a switching circuit 104, and a write amplifier 107 for converting write data into recording current. The switching circuit 104 is a circuit for switching an output of the differentiation circuit 103 and an output of the read amplifier 100, and sending either of the outputs, as a result, it realizes the function for turning on/off the differentiation circuit 103.

The differentiation circuit 103 has differentiation characteristics at least in a frequency band where a signal element of the read signal exists, and has the function to convert a read rectangular waveform signal of the perpendicular magnetic recording system into a read signal waveform of the longitudinal magnetic recording system. The differentiation circuit 103 concretely has a high-pass filter (HPF) having the same cut-off frequency characteristics as the frequency band wherein a signal element exists.

The R/W channel 11 has a signal processing circuit 110 including a data modulation/demodulation circuit and a servo demodulation circuit, and a TA detection circuit 111. The signal processing circuit 110 normally comprises a data channel of a partial response maximum likelihood (PRML) method. The data demodulation circuit executes the signal processing of the PRML method, and decodes data from the reproduction signal after differentiation processing sent from the preamplifier circuit 10. The data modulation circuit executes, for example, RLL encoding processing to write data sent from the HDC 9. The servo demodulation circuit demodulates various servo signals or servo data from the read signal (differentiation signal) read by the read head from a servo area (servo sector area) on a disk 1 to be described later.

The HDC 12 configures an interface between a drive and a host system (a personal computer or a digital device), and executes the transfer control of read/write data and the like. The HDC 9 sends out the function to create data read gate (DRG) and data write gate necessary for control of read/write operation, and a switching control signal 90 of a switching circuit 102 according to the embodiment. In this case, a magnetic head 3, an actuator, CPU 14, memories 15 and a motor driver 13 are same in the first embodiment described already, therefore, their explanations are omitted here.

Herein, the disk 1, as mentioned above, is supposed to be a double-layered disk medium of the perpendicular magnetic recording system. The disk is rotated at high speed by a spindle motor 2 at data read/write operation. The disk 1 is equipped with a servo sector 200 as the servo area to which servo data to be used by head positioning control (servo control) is recorded by a special device called a servo writer at its production. Plural servo sectors 200 are arranged at predetermined intervals in a circumferential direction. On the disk 1, many tracks 201 including the servo sectors 200 are structures in concentric circle manner. Other area than the servo sector 200 on each track 201 is a data area 202 onto which basically data (user data) is recorded.

(TA Phenomenon in Perpendicular Magnetic Recording System)

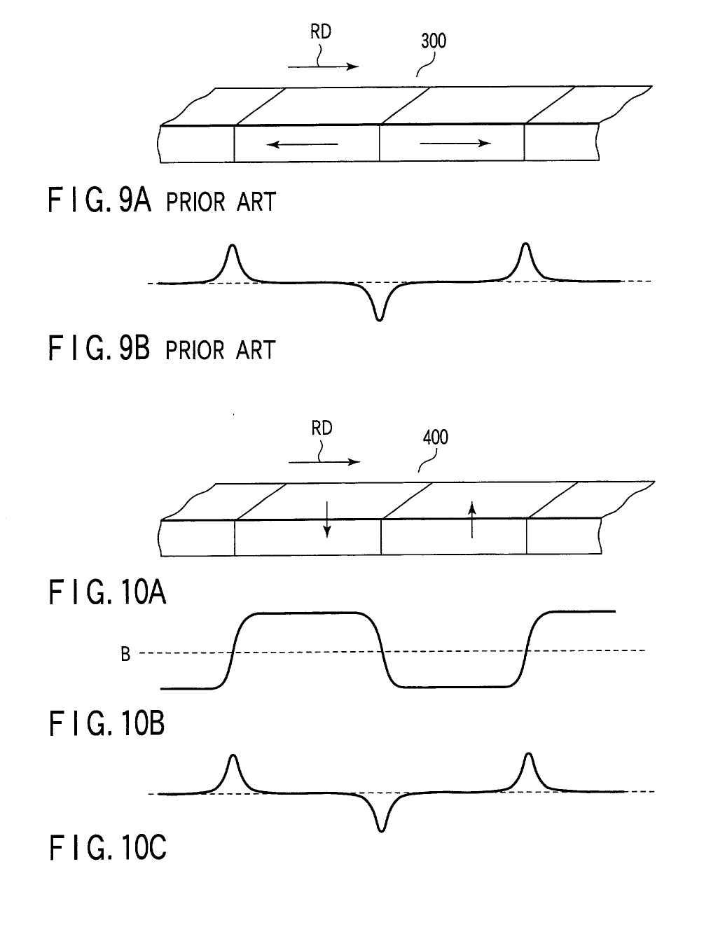

First, in a disk drive of the conventional longitudinal magnetic recording system, as shown in FIG. 9A, when digital data (0/1) is recorded into a data track 300, a magnetic area (arrow marking) corresponding to the data concerned is formed in the longitudinal direction of the disk 1 (rotational direction RD). In this case, maximum amplitude appears in an area where the magnetic direction shifts (magnetic shift area), and amplitude polarity varies with shift from positive direction magnetization to negative direction magnetization, and shift from negative direction magnetization to positive direction magnetization. When magnetic data recorded in the disk 1 is read by the read head, a read signal of waveform as shown in FIG. 9B is output.

On the contrary, in the perpendicular magnetic recording system, as shown in FIG. 10A, when digital data (0/1) is recorded into a data track 400, a magnetic area corresponding to the data is formed in the perpendicular direction (depth direction) of the disk. In the perpendicular magnetic recording system, in a read signal read by the read head, as shown in FIG. 10B, amplitude shifts at a magnetic shift area, and amplitude becomes a signal waveform of rectangular waveform corresponding to the direction of magnetization.

In a disk drive according to the embodiment, the read signal of rectangular waveform is differentiated by the differentiation circuit 103 included in the preamplifier 10, and as shown in FIG. 10C, it is converted into the same read signal waveform (differentiation waveform) as the case of the longitudinal magnetic recording system.

While, as mentioned above, in recent disk drives, a head having a structure wherein a read head and a write head are separately packaged on a slider is employed, as the magnetic head 3. The structure of the write head varies with the longitudinal magnetic recording system and the perpendicular magnetic recording system, while, the read head comprises a GMR element in both systems. The magnetic head 3 (slider) executes read/write action, afloat from the surface of the disk 1.

On the other hand, the surface of the disk 1 is made flat well so that the head should not impact the disk surface. However, on the surface of a disk, there exists rarely an abnormal protrusion exceeding the flying height of the head, and dust. These may cause the head to impact the surface of the disk 1 which is rotating at high speed. At such an impact of the head, the temperature of such a impacted portion goes up rapidly after impact, and goes down gradually to the original normal level.

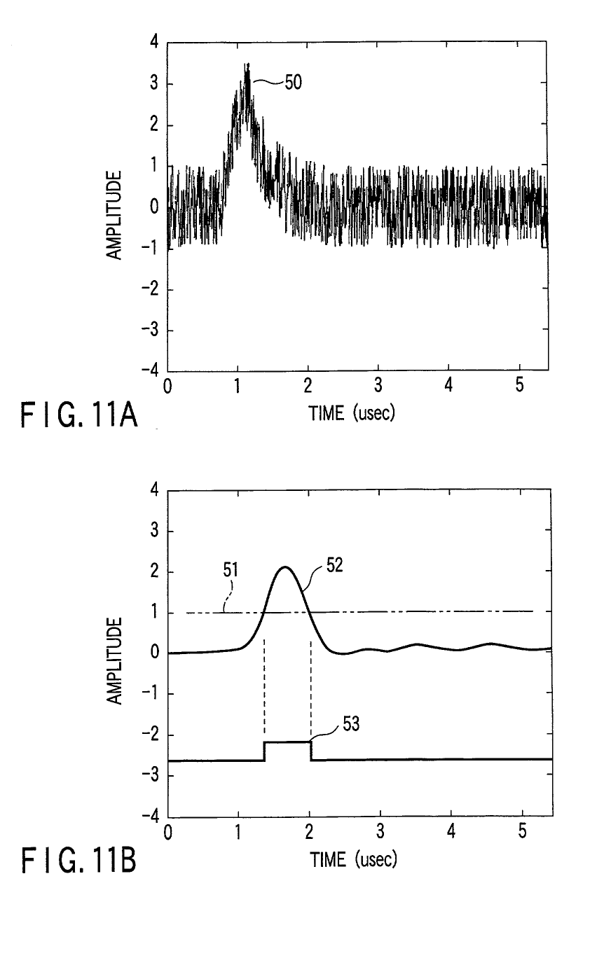

Herein, if the impacted portion is on or in the vicinity of the GMR element, resistance change in proportion with the temperature change by impact occurs on the GMR element. The GMR element reproduces a signal from the resistance change by a magnetic field from the disk 1. Accordingly there occurs a phenomenon wherein by resistance change of the GMR element caused by temperature change owing to the head impact, as shown in FIG. 11A, a read signal waveform including an erroneous amplitude 50 (when the frequency of recorded data is 400 MHz) is output from the read head. This phenomenon is generally called thermal asperity (TA) in the field of disk drive.

At the event of such a TA phenomenon, besides the problem that data cannot be decoded correctly from a read signal, there is another problem that the head will hit such an abnormal protrusion on the disk 1 frequently. Namely, the protrusion on the disk is ground by impact with the head, and ground chips attach and collect on the head, which finally may cause a fatal accident, head crush.

As shown in FIG. 1lB, the TA detection circuit, outputs a TA detection signal (pulse) 53 when an erroneous amplitude exceeding a certain amplitude value (TA detection threshold value 51) continues for a certain time or more. In concrete, the TA detection circuit comprises a comparator that compares an output signal (read signal 52) of a low-pass filter (LPF) by the TA detection threshold value 51. The CPU of the disk drive measures the time when the TA detection signal 53 gets at high level, and when the time is a certain time or more, the CPU recognizes that a TA phenomenon has occurred. The LPF has cut-off frequency enough to remove almost of the signal components of the read signal (for example, 1 MHz), and extracts only TA components.

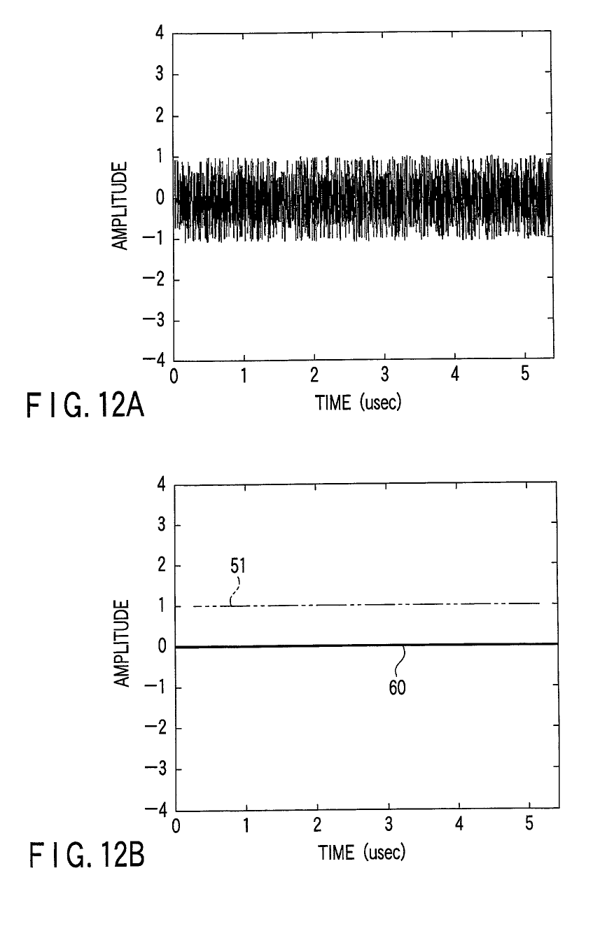

On the other hand, in a disk drive of the perpendicular magnetic recording system, the read signal output from the read head is differentiated by the differentiation circuit 103 of the preamplifier 10. Therefore, as shown in FIG. 12A, an erroneous amplitude portion by TA is buried under the read signal after differentiation. This is because the time interval of occurrence of the erroneous amplitude by TA is generally several μsec order, which is relatively longer than the frequency of the read signal of data. Herein, as shown in FIG. 12B, when a read signal after differentiation (differentiation signal) 60 passes an LPF having the same cut-off frequency as the above (for example, 1 MHz), an erroneous amplitude signal by TA hardly occurs, so it is impossible to detect TA by the TA detection circuit.

(Data Reproduction Operation and TA Detection Operation)

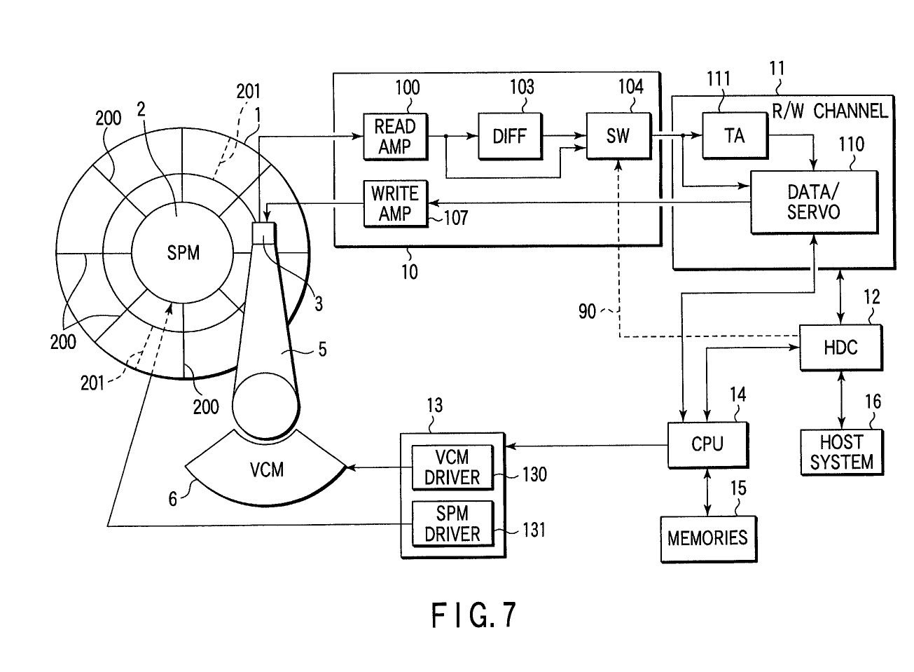

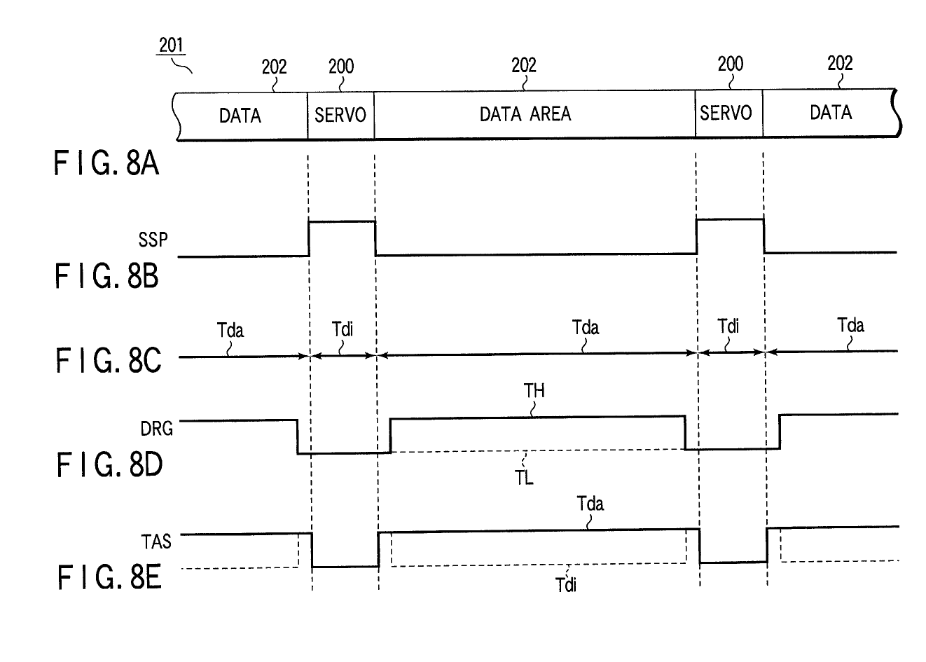

Accordingly, in the disk drive of the perpendicular magnetic recording system according to the embodiment, the TA detection circuit 111 included in the R/W channel 11 starts its TA detection operation from the read signal before differentiation (the output of the read amplifier 100), in other words, the TA detection operation according to the embodiment is not executed during reproduction operation of data and servo signal, in accordance with the control of the HDC 9. Hereinafter, in reference to FIGS. 8A to 8E, the TA detection operation according to the embodiment will be explained.

The HDC 9, sends the switching control signal 90 of the switching circuit 102 on the basis of respective timings of servo sector pulse SSP and data read gate DRG. This switching control signal 90 becomes a signal equivalent to a TA detection permit signal TAS that controls to turn off (disable) the output of the differentiation circuit 103 when the execution of TA detection operation is available (high level signal shown in FIG. 8E).

FIG. 8A is a diagram showing a track format on the disk 1. TA detection operation is not executed in the area of the servo sector 200, but is executed when the read head is positioned in the data area 202. Namely, as shown in FIG. 8G, a period Tda corresponding to the data area 202 is an available period of TA detection operation, while a period Tdi corresponding to the servo sector 200 is a prohibition period of TA detection operation.

The HDC 9 and the CPU 6 judge by use of the servo sector pulse SSP whether or not the head 3 is positioned on the servo sector 200. As shown in FIG. 8B, the servo sector pulse SSP is a signal that gets at high level during the period when the head 3 (read head 9 reproduces a servo signal from the servo sector 200. The servo sector pulse SSP is generated by the read/write channel 11 on the basis of a predetermined signal (servo mark) read by the read head from the servo sector 200. The servo sector pulse SSP is used as a standard signal for determining the timing of read/write operation of the data area 202, and also used as a gate signal for masking so that servo data (servo signal) prerecorded in the servo sector 200 should not be deleted by overwriting.

While this servo sector pulse SSP is at high level, the switching circuit 104 maintains the output of the differentiation circuit 103 at ON (valid) state, and sends the read signal (differentiation signal) from the differentiation circuit 103 to the R/W channel 11. Namely, the differentiation circuit 103 differentiates the read signal amplified by the read amplifier 100, by the servo signal read by the read head from the servo sector 200.

In the R/W channel 11, the servo demodulation circuit included in the signal processing circuit 110 demodulates servo data (servo signal) from the read signal (differentiation signal) from the differentiation circuit 103. At this moment, as shown in FIG. 2E, the permit signal TAS of the TA detection operation is at low level, and the TA detection circuit 111 of the R/W channel 11 is in function suspended state (action prohibited state).

On the other hand, as shown in FIG. 8C, when the servo sector pulse SSP is in its low level period, TA detection operation is in its available period. However, during data reproduction operation wherein a data signal is read from the data area 202 and user data is regenerated (decoded), TA detection operation is prohibited (not permitted). During the data reproduction operation, as shown in FIG. 8D, the data read gate (DRG) is in its high level period (TH). Namely, when the data read gate (DRG) is in its high level period (TH), the switching circuit 102 maintains the output of the differentiation circuit 103 at ON (valid) state, and sends the read signal from the differentiation circuit 103 to the R/W channel 11.

The differentiation circuit 103 differentiates the read signal amplified by the read amplifier 100, by the data signal read by the read head from the data area 202. In the R/W channel 11, the data demodulation circuit included in the signal processing circuit 110 demodulates (decodes) user data from the read signal (differentiation signal) from the differentiation circuit 103.

TA detection operation by the TA detection circuit 111 becomes available under the conditions that both the servo sector pulse SSP and the data read gate DRG are at low level period (period TL). As shown in FIG. 8E, the DHC 9 sends out the switching control signal 90 equivalent to the TA detection permit signal TAS that becomes high level at the period Tda to meet the conditions. The switching circuit 102 turns off (disables) the output of the differentiation circuit 103 according to the switching control signal 90, and controls to send the output of the read amplifier 100 as it is. In the R/W channel 11, according to the TA detection permit signal TAS, the operation of the TA detection circuit 111 becomes available, and the TA detection operation of the read signal sent from the preamplifier circuit 10 is executed.

Since the output of the differentiation circuit 103 is in OFF state, the TA detection circuit 111 inputs the read signal not differentiated (refer to FIG. 10B) from the read amplifier 100, and detects erroneous amplitude from the read signal. The CPU 14 executes the conventional TA detection method for specifying the TA detection position in the data area 202 and the like, according to the detection results (detection of erroneous amplitude) from the TA detection circuit 111. The TA detection circuit 111 may output the detection results to the CPU 14 without via the signal processing circuit 110.

As mentioned heretofore, according to the embodiment, it is possible, by the preamplifier 10 including the differentiation circuit 103, to convert the read signal obtained from the disk 1 of the perpendicular magnetic recording system into the read signal (differentiation waveform) of the longitudinal magnetic recording system. As a consequence, as the signal processing circuit 110 in the R/W channel 11, a PRML method data demodulation circuit or one suitable for a disk drive of the longitudinal magnetic recording system may be employed as it is.

On the other hand, the TA detection circuit 111 is arranged not in the preamplifier circuit 10, but in the R/W channel 11. The preamplifier circuit 10 has the switching circuit 104, and at TA detection operation, it sends the read signal output from the read amplifier 100 to the TA detection circuit 111. At read operation, the preamplifier circuit 10 sends the read signal (differentiation signal) output from the differentiation circuit 103 to the signal processing circuit 110.

According to the embodiment, there is no need to arrange the TA detection circuit 111 in the preamplifier circuit 10 as the front stage circuit of the differentiation circuit 103. Accordingly, it is possible to prevent the circuit size or the number of signal wires from becoming large along with the arrangement of the TA detection circuit 111. Thereby, it is possible to make compact the circuit size of the preamplifier circuit 10, and realize diversity in designing disk drives wherein, for example, the preamplifier circuit may be packaged onto actuator suspension or the like.

As described in detail heretofore, according to the present invention, in a disk drive using a preamplifier circuit including a differentiation circuit, it is possible to solve the limitation in circuit design that a TA detection circuit must be arranged in a preamplifier circuit. As a consequence, it is possible to prevent a circuit size and the number of signal wires between read channel and write channel from becoming large in designing a preamplifier circuit. In summary, it is possible to realize the preamplifier circuit including the differentiation circuit, and the read/write channel of the longitudinal magnetic recording system, and the TA detection circuit in the read/write channel respectively, as a result, it is possible to promote practical applications of the disk drive of the perpendicular magnetic recording system.

What is claimed is:

1. A disk drive comprising:
a disk medium for perpendicular magnetic recording;
a read head which reads a perpendicular magnetic recorded data signal from the disk medium;
a preamplifier circuit including a read amplifier which amplifies a read signal output from the read head, and a differentiation circuit which differentiates a read signal output from the amplifier; and
a data channel which reproduces data from the read signal output from the preamplifier circuit.

2. The disk drive according to claim 1, wherein
the preamplifier circuit includes an adjusting circuit to adjust low cut-off frequency of the signal output from the read amplifier.

3. The disk drive according to claim 2, wherein
the adjusting circuit comprises a filter circuit which adjusts the low cut-off frequency to 50 kHz or less or in the range of from 1/2000 or less of the maximum recording frequency of the disk medium to a DC level.

4. The disk drive according to claim 1, wherein
the data channel includes a read channel which executes a reproduction signal processing of a longitudinal magnetic recording system to the read signal, and restores the perpendicular magnetic recorded data onto the disk medium.

5. The disk drive according to claim 1, wherein
the preamplifier circuit includes a TA detection circuit to detect occurrence of thermal asperity of the read head from the read signal output from the preamplifier circuit.

6. The disk drive according to claim 1, wherein
the preamplifier circuit includes a gain adjusting circuit to adjust a gain of the read signal.

7. The disk drive according to claim 1, wherein
the preamplifier circuit includes a selection circuit which selects one of the read signal output from the differentiation circuit and the read signal output from the read amplifier, and sends the selected one to the data channel.

8. A preamplifier device for a disk drive including a disk medium for perpendicular magnetic recording and a read head data from the disk medium, said preamplifier device comprising:
a read amplifier which amplifies a read signal output from the read head;
an adjusting circuit which adjusts low cut-off frequency of a read signal output from the read amplifier; and
a differentiation circuit which differentiates the read signal adjusted by the adjusting circuit.

9. The preamplifier device according to claim 8, further comprising:
a circuit which sends the read signal output from the differentiation circuit to a data channel included in the disk drive, the data channel restoring perpendicular magnetic recorded data onto the disk medium.

10. The preamplifier device according to claim 8, wherein
the adjusting circuit comprises a filter circuit which adjust the low cut-off frequency to 50 kHz or less or in the range of from 1/2000 or less of the maximum recording frequency of the disk medium to a DC level.

11. The preamplifier device according to claim 8, further comprising:
a selection circuit which selects one of the read signal output from the differentiation circuit and the read signal output from the read amplifier, and sends the selected one to a data channel included in the disk drive.

12. The preamplifier device according to claim 11, wherein
the selection circuit further comprises a circuit 25 which sends the read signal output from the differentiation circuit to a data channel included in the disk drive, the data channel restoring the perpendicular magnetic recorded data onto the disk medium.

13. The preamplifier device according to claim 8, wherein
the read amplifier comprises a direct current (DC) amplifier circuit,
and further comprising;
an input circuit to input a bias adjusting signal for adjusting a bias level of the DC amplifier circuit from the external.

14. The preamplifier device according to claim 11, further comprising:
a power controller which shuts down power supply to the differentiation circuit when the read signal output from the differentiation circuit is not selected by the selection circuit.

15. A disk drive comprising:
a disk medium for perpendicular magnetic recording;
a read head which reads a perpendicular magnetic recorded data signal from the disk medium;
a preamplifier circuit including a read amplifier which amplifies a read signal output from the read head, and a differentiation circuit which selectively differentiates a read signal output from the amplifier; and
a TA detection circuit to detect occurrence of thermal asperity of the read head from the read signal output from the preamplifier circuit without being differentiated by the differentiation circuit.

16. The disk drive according to claim 15, wherein
the TA detection circuit is included in a data channel which restores perpendicular magnetic recorded data from the read signal onto the disk medium.

17. The disk drive according to claim 15, wherein
the disk medium has a servo area wherein servo data is recorded and a user data area wherein user data is recorded,
and further comprising;
a selection circuit which outputs the servo data without differentiation processing by the preamplifier circuit while the servo data recorded in the servo area is being read from the read head, and outputs the user data differentiated by the preamplifier circuit while the user data recorded in the user data area is being read from the read head.

18. The disk drive according to claim 15, wherein
the preamplifier circuit includes a selection circuit which selects one of the read signal output from the differentiation circuit and the read signal output from the read amplifier;
the TA detection circuit is included in a data channel which restores the perpendicular magnetic recorded data from the read signal onto the disk medium;
and further comprising;
a controller which controls the selection circuit to send the read signal output from the differentiation circuit to the data channel at read operation, disables the output of the differentiation circuit at detection operation of the thermal asperity, and sends the read signal output from the read amplifier to the TA detection circuit.

19. The disk drive according to claim 18, wherein
the controller, when reproducing a servo signal recorded in the servo area of the disk recording medium, controls the selection circuit to send the read signal output from the differentiation circuit to the data channel.

20. The disk drive according to claim 18, wherein
the controller controls the selection circuit by use of a read gate signal for determining the timing at the read operation and a permit signal for instructing permission for detection operation of the thermal asperity, and
controls to enable the output of the differentiation circuit at the read operation, while disable the output of the differentiation circuit at detection operation of the thermal asperity.

21. The disk drive according to claim 17, wherein
the controller controls the selection circuit by use of a servo sector pulse for determining the timing of reproduction operation of the servo data and a prohibition signal for instructing prohibition of detection operation of the thermal asperity, and
controls to enable the output of the differentiation circuit at reproduction operation of the servo data.

22. The disk drive according to claim 17, wherein
the read head has a GMR element, and configures a magnetic head together. with a write head that enables perpendicular magnetic recording;
the preamplifier circuit includes the read amplifier, and a write amplifier to provide a write signal to the write head; and
the data channel includes a data decoding circuit which reproduces user data from the read signal output from the preamplifier, a servo demodulation circuit which reproduces servo data from the read signal, and a write data encoding circuit which corresponds to the write signal.
